(19) United States
(12) Patent Application Publication
(10) Pub. No.: US 2026/0329988 A1
(43) Pub. Date: Oct. 22, 2026

(54) CUSTOMIZED CONTROLS FOR SECURE WEB SESSIONS

(71) Applicant: CyberArk Software Ltd., Petach-Tikva (IL)

(72) Inventors: Nir POPIK, Petach-Tikva (IL); Ari Brian SCHWARTZ, Petach-Tikva (IL); Tamar YANKELEVICH, Petach-Tikva (IL); Arthur BENDERSKY, Petach-Tikva (IL)

(73) Assignee: CyberArk Software Ltd., Petach-Tikva (IL)

(21) Appl. No.: 19/560,447

(22) Filed: Mar. 9, 2026

Related U.S. Application Data
(62) Division of application No. 18/375,127, filed on Sep. 29, 2023.
(60) Provisional application No. 63/446,659, filed on Feb. 17, 2023.

(51) Int. Cl. G06F 21/31; G06F 21/62

(52) U.S. Cl. CPC G06F 21/31; G06F 21/629

(57) ABSTRACT

Disclosed embodiments relate to systems and methods for controlling web sessions. Techniques include identifying, by a browser component executing on an endpoint device, navigation by a user to a web application, the web application including at least one interface element; accessing, based on an identifier of the at least one interface element, at least one rule associated with the at least one interface element; identifying an interaction with the at least one interface element by the user; determining whether the interaction with the at least one interface element triggers the at least one rule; and based on a determination that the interaction with the at least one interface element triggers the at least one rule, causing a control action to be performed.

### CROSS REFERENCE TO RELATED APPLICATION

This application claims the benefit of priority of U.S. Provisional Application No. 63/446,659, filed Feb. 17, 2023. The foregoing application is incorporated herein by reference in its entirety.

### BACKGROUND

### Technical Field

The present disclosure relates generally to cybersecurity and, more specifically, to techniques for monitoring and controlling web sessions.

### Background Information

Individuals and organizations are increasingly relying on a greater number of different software applications for business as well as personal use. As each software application may require authentication of the user to access the software, it may also be increasingly burdensome on individuals and organizations to maintain separate credentials for each software application. Many software vendors offer single sign-on (SSO) techniques for conveniently accessing these resources. In particular, these approaches provide a uniform way for users to authenticate just once to a trusted system, referred to as an identity provider (IDP), and afterwards be able to access other systems without being prompted for separate authentication.

The use of SSO solutions has been applied to web applications as well, allowing administrators to track and control access of users to web applications. Web application administrators often have many tools for protecting and controlling data outside of a web application session. For example, this may include defining roles and privileges to dictate which users can access which applications, monitoring and storing data during the session, or other techniques. However, administrators often have limited control over what occurs during a web application session. In other words, once a user has begun a web application session, administrators often have little control or visibility over actions the user takes within various web applications.

Some existing techniques may integrate with specific applications using built-in integrations to provide some control over use of the application. However, because these integrations are application-specific, they require more in-depth setup and maintenance. They also often require a more significant intervention to control user traffic either through an on-premises connector or a cloud gateway. Accordingly, in view of these and other deficiencies in current techniques, technical solutions are needed to efficiently provide control over applications during a web session. Solutions should advantageously be applied on a per-element basis within an application, rather than a per-application basis. Solutions should also allow for intuitive set up of controls by administrators with minimal impact to user experience or performance.

### SUMMARY

The disclosed embodiments describe non-transitory computer readable media, systems, and methods for controlling web sessions. For example, in an embodiment, a non-transitory computer readable medium may include instructions that, when executed by at least one processor, cause the at least one processor to perform operations for controlling web sessions. The operations may comprise identifying, by a browser component executing on an endpoint device, navigation by a user to a web application, the web application including at least one interface element; accessing, based on an identifier of the at least one interface element, at least one rule associated with the at least one interface element; identifying an interaction with the at least one interface element by the user; determining whether the interaction with the at least one interface element triggers the at least one rule; and based on a determination that the interaction with the at least one interface element triggers the at least one rule, causing a control action to be performed.

According to a disclosed embodiment, the interaction with the at least one interface element may include a value being input by the user and wherein determining whether the interaction with the at least one interface element triggers the at least one rule may include determining whether the value triggers the at least one rule.

According to a disclosed embodiment, the user may input the value by selecting from a closed list of available values.

According to a disclosed embodiment, determining whether the value triggers the at least one rule may include determining whether the value is within an accepted range of values.

According to a disclosed embodiment, determining whether the value triggers the at least one rule may include determining whether the value includes at least one restricted value.

According to a disclosed embodiment, the control action may include changing the value to a modified value that does not trigger the at least one rule.

According to a disclosed embodiment, the control action may include restricting an interaction with at least one additional interface element of the web application by the user.

According to a disclosed embodiment, the control action may include causing a message to be presented to the user, the message indicating the interaction with the at least one interface element triggers the at least one rule.

According to a disclosed embodiment, causing the message to be presented may include causing the message to be overlaid on the web application.

According to a disclosed embodiment, the control action may include causing transmission of an alert indicating the at least one rule has been triggered.

According to a disclosed embodiment, the control action may include locking the endpoint device.

According to a disclosed embodiment, the operations may further include validating an identity of the user.

According to a disclosed embodiment, determining whether the interaction with the at least one interface element triggers the at least one rule may be based on the identity of the user.

According to a disclosed embodiment, the control action may include triggering an additional authentication of the identity of the user.

According to a disclosed embodiment, the control action may include storing information identifying at least one of the user or the interaction with the at least one interface element.

According to a disclosed embodiment, the identifier of the at least one interface element may include at least one of a name of the at least one interface element or an indicator of a position of the at least one interface element.

According to a disclosed embodiment, the at least one interface element may include a first interface element and a second interface element, and the interaction with the at least one interface element includes an interaction with the first interface element and an interaction with the second interface element by the user; and the determination whether the interaction with the at least one interface element triggers the at least one rule may be based on the interaction with the first interface element and the interaction with the second interface element.

According to another disclosed embodiment, there may be a computer-implemented method for controlling web sessions. The method may comprise identifying, by a browser component executing on an endpoint device, navigation by a user to a web application, the web application including at least one interface element; accessing, based on an identifier of the at least one interface element, at least one rule associated with the at least one interface element determining the at least one rule is associated with the at least one interface element; identifying an interaction with the at least one interface element by the user; determining whether the interaction with the at least one interface element triggers the at least one rule; and based on a determination that the interaction with the at least one interface element triggers the at least one rule, causing a control action to be performed.

According to a disclosed embodiment, the method may further include creating the at least one rule based on an input by at least one additional user.

According to a disclosed embodiment, the input from at least one additional user may be received in association with the at least one element when the at least one additional user navigates to the web application.

According to a disclosed embodiment, the method may further include: detecting the at least one interface element; and causing an indicator to be displayed in association with the at least one interface element, wherein the input by the at least one additional user is received through an interaction with the indicator.

According to a disclosed embodiment, creating the at least one rule may further include causing a rule creation interface to be displayed in association with the at least one interface element, and wherein the input by the at least one additional user is received through the rule creation interface.

According to a disclosed embodiment, the rule creation interface may be overlaid on the web application.

According to a disclosed embodiment, the method may further include modifying the at least one rule based on an additional input by the at least one additional user.

According to a disclosed embodiment, the input from at least one additional user may be received in association with recorded browser session data.

According to a disclosed embodiment, the method may further include: accessing a plurality of stored rules, each of the plurality of stored rules being associated with a corresponding interface element; and generating a suggestion to the at least one additional user to create the at least one rule based on the plurality of stored rules.

According to a disclosed embodiment, generating the suggestion may include identifying the at least one rule based on a comparison of at least one attribute of the at least one interface element with attributes of interface elements associated with the plurality of stored rules.

According to a disclosed embodiment, the input by the at least one additional user may include information defining a condition associated with the at least one interface element, wherein the determination of whether the interaction with the at least one interface element triggers the at least one rule is based on a comparison of the interaction with the at least one interface element with the condition.

According to a disclosed embodiment, the information defining a condition associated with the at least one interface element may be received through a rule creation interface and wherein an appearance of the rule creation interface is determined based on a type of the at least one interface element.

According to a disclosed embodiment, the input by the at least one additional user may include information defining the control action.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an example system environment for securely and privately auditing web sessions, consistent with the disclosed embodiments.

FIG. 2A is a block diagram showing an example server, consistent with the disclosed embodiments.

FIG. 2B is a block diagram showing an example endpoint device, consistent with the disclosed embodiments.

FIG. 3 illustrates an example browser application through which a web application may be accessed, consistent with the disclosed embodiments.

FIG. 4 illustrates an example view of a web application for generating rules, consistent with the disclosed embodiments.

FIG. 5 illustrates an example rule creation interface that may enable a user to generate one or more rules for web sessions, consistent with the disclosed embodiments.

FIG. 6 illustrates an example rule management interface for managing rules, consistent with the disclosed embodiments.

FIG. 7 is a flowchart showing an example process for controlling web sessions, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for controlling web sessions described herein overcome several technological problems relating to security, efficiency, and performance in the fields of cybersecurity and network security. As discussed above, web application administrators often have limited control or visibility, if any, over actions the user takes during a web application session. While some existing techniques allow for control over specific web applications, technical solutions are needed to efficiently provide control over applications on a per-element basis within an application, rather than a per-application basis.

To address these and various other deficiencies, the disclosed techniques provide browser components (e.g., browser applications or plugins), allowing administrators to generate rules associated with individual elements within a web application. The same or similar browser component may be executing on a user's endpoint device when the user accesses the web application. The browser component may identify specific elements included on the web application and access rules stored in association with the identified elements. Accordingly, the disclosed techniques allow rules to be enforced for individual elements across a wide variety of web applications. Further the disclosed techniques include improved interfaces allowing an administrator to easily generate, view, modify, and manage rules associated with these individual interface elements.

Reference will now be made in detail to the disclosed embodiments, examples of which are illustrated in the accompanying drawings.

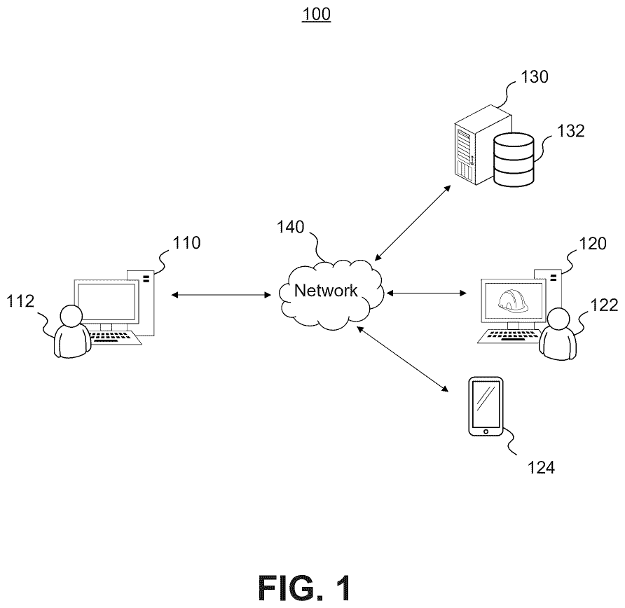

FIG. 1 illustrates an example system environment 100 for creating, managing, and implementing controls for secure web sessions, consistent with the disclosed embodiments. System environment 100 may include one or more user endpoint devices 110, one or more administrator endpoint devices 120, and one or more servers 130, as shown in FIG. 1. System environment 100 may represent a system or network environment in which a user 112 engages in a web session through user endpoint device 110. As used herein, a web session may refer to a series of actions or activities performed by a user or application within one or more web applications over a given time frame. In some embodiments, a web session may be an authenticated web session, such as a SSO session. Accordingly, a user (e.g., user 112) may input or otherwise assert one or more credentials to begin the web session. Once authenticated and/or authorized, the user may perform various activities in one or more applications. For example, this may include navigating through and/or between web applications, interacting with control elements (e.g., buttons, links, selection boxes, etc.), inputting values into control elements (e.g., entering text, etc.), or various other activities.

System 100 may allow for these web sessions to be monitored and may provide controls over these activities. In particular, the below techniques may detect various interface elements within web applications, identify rules associated with the interface elements, monitor and detect interactions with the interface elements, and determine whether the interactions trigger the rules. In some embodiments, an administrator 122 may create and/or modify these rules using an administrator endpoint device 120. If a rule is triggered, various control actions may be performed, as described in further detail below.

The various components of system 100 may communicate over a network 140. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 100 is shown as a network-based environment, it is understood that in some embodiments, one or more aspects of the disclosed systems and methods may also be used in a localized system, with one or more of the components communicating directly with each other.

User endpoint device 110 may be configured such that user 112 may access a web session through a browser or other software executing on user endpoint device 110. Activity of user 112 during the web session may be monitored to enforce one or more controls over the web session. User endpoint device 110 may include any form of computer-based device or entity through which user 112 may access a protected navigation location. For example, user endpoint device 110 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may be capable of accessing web pages or other network locations. In some embodiments, user endpoint device 110 may be a virtual machine (e.g., based on AWS™, Azure™, IBM Cloud™, etc.), container instance (e.g., Docker™ container, Java™ container, Windows Server™ container, etc.), or other virtualized instance.

User endpoint device 110 may communicate with server 130 through network 140. For example, server 130 may enable user endpoint device 110 to access one or more rules associated with web session activities. In some embodiments, user endpoint device 110 may further transmit recorded web session activity of user 112 to server 130. Server 130 may include any form of remote computing device configured to receive, store, and transmit information associated with web session activity rules. For example, server 130 may be a server configured to store files accessible through a network (e.g., a web server, application server, virtualized server, etc.). Server 130 may be implemented as a Software as a Service (SaaS) platform through which software for auditing user web session activity may be provided to an organization as a web-based service. In some embodiments, server 130 may include or access a database 132 configured to store one or more rules associated with web session activities.

Administrator endpoint device 120 may similarly communicate with server 130 through network 140. For example, an administrator 122 may use administrator endpoint device 120 to generate rules for controlling or monitoring activities performed through user endpoint device 110. In some embodiments, administrator endpoint device 120 may further allow administrator 122 to access and view recorded web session activity stored on server 130. Administrator endpoint device 120 may include any computing device configured to enable a user to view, create, and/or manage rules associated with user web sessions. For example, administrator endpoint device 120 may be a personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may allow a user to manage web session activity rules. In some embodiments, user endpoint device 110 may be a virtual machine (e.g., based on AWS™, Azure™, IBM Cloud™, etc.), container instance (e.g., Docker™ container, Java™ container, Windows Server™ container, etc.), or other virtualized instance.

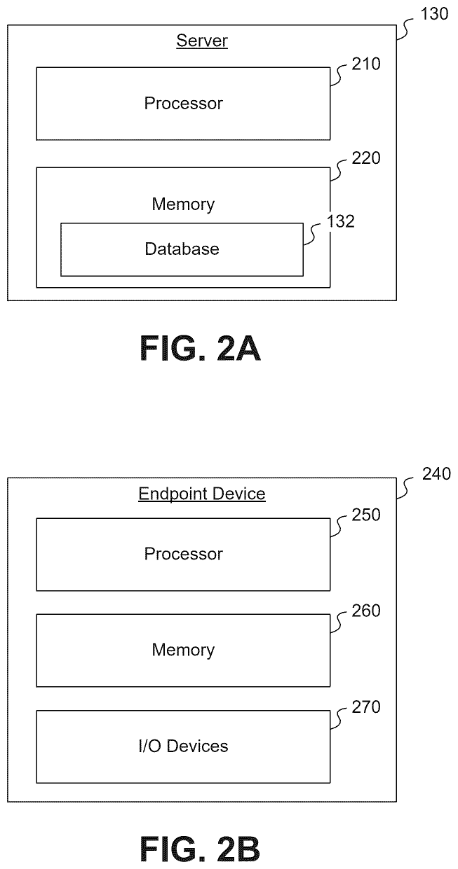

FIG. 2A is a block diagram showing an example server 130, consistent with the disclosed embodiments. As described above, server 130 may be a computing device (e.g., a server, etc.) and may include one or more dedicated processors and/or memories. For example, server 130 may include a processor (or multiple processors) 210, and a memory (or multiple memories) 220, as shown in FIG. 2A.

Processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. The processor 210 may also be based on the ARM architecture, a mobile processor, or a graphics processing unit, etc. The disclosed embodiments are not limited to any type of processor configured in server 130.

Memory 220 may include one or more storage devices configured to store instructions used by the processor 210 to perform functions related to server 130. The disclosed embodiments are not limited to particular software programs or devices configured to perform dedicated tasks. For example, the memory 220 may store a single program, such as a user-level application, that performs the functions associated with the disclosed embodiments, or may comprise multiple software programs. Additionally, the processor 210 may, in some embodiments, execute one or more programs (or portions thereof) remotely located from server 130. Furthermore, memory 220 may include one or more storage devices configured to store data for use by the programs. Memory 220 may include, but is not limited to a hard drive, a solid state drive, a CD-ROM drive, a peripheral storage device (e.g., an external hard drive, a USB drive, etc.), a network drive, a cloud storage device, or any other storage device.

In some embodiments, memory 220 may include a database 132 as described above. Database 132 may be included on a volatile or non-volatile, magnetic, semiconductor, tape, optical, removable, non-removable, or other type of storage device or tangible or non-transitory computer-readable medium. Database 132 may also be part of server 130 or separate from server 130. When database 132 is not part of server 130, server 130 may exchange data with database 132 via a communication link. Database 132 may include one or more memory devices that store data and instructions used to perform one or more features of the disclosed embodiments. Database 132 may include any suitable databases, ranging from small databases hosted on a work station to large databases distributed among data centers. Database 132 may also include any combination of one or more databases controlled by memory controller devices (e.g., server(s), etc.) or software. For example, database 132 may include document management systems, Microsoft SQL™ databases, SharePoint™ databases, Oracle™ databases, Sybase™ databases, other relational databases, or non-relational databases, such as mongo and others.

FIG. 2B is a block diagram showing an example endpoint device 240, consistent with the disclosed embodiments. Endpoint device 240 may correspond to one or both of user endpoint device 110 and administrator endpoint device 120. As shown in FIG. 2B, endpoint device 240 may include a processor (or multiple processors) 250, a memory (or multiple memories) 260, and/or one or more input/output (I/O) devices 270, as shown in FIG. 2B.

As with processor 210, processor 250 may take the form of, but is not limited to, a microprocessor, embedded processor, or the like, or may be integrated in a system on a chip (SoC). Furthermore, according to some embodiments, processor 250 may be from the family of processors manufactured by Intel®, AMD®, Qualcomm®, Apple®, NVIDIA®, or the like. The processor 250 may also be based on the ARM architecture, a mobile processor, or a graphics processing unit, etc. The disclosed embodiments are not limited to any type of processor configured in endpoint device 240.

Further, similar to memory 220, memory 260 may include one or more storage devices configured to store instructions used by the processor 250 to perform functions related to endpoint device 240. The disclosed embodiments are not limited to particular software programs or devices configured to perform dedicated tasks. For example, the memory 260 may store a single program, such as a user-level application (e.g., a browser), that performs the functions associated with the disclosed embodiments, or may comprise multiple software programs. Additionally, the processor 250 may, in some embodiments, execute one or more programs (or portions thereof) remotely located from endpoint device 240 (e.g., located on server 130). Furthermore, memory 260 may include one or more storage devices configured to store data for use by the programs. Memory 260 may include, but is not limited to, a hard drive, a solid state drive, a CD-ROM drive, a peripheral storage device (e.g., an external hard drive, a USB drive, etc.), a network drive, a cloud storage device, or any other storage device.

I/O devices 270 may include one or more network adaptors or communication devices and/or interfaces (e.g., WIFI, BLUETOOTH, RFID, NFC, RF, infrared, Ethernet, etc.) to communicate with other machines and devices, such as with other components of system environment 100 through network 140. For example, endpoint device 240 may use a network adaptor to receive and transmit communications pertaining to user web session activity within system environment 100. In some embodiments, I/O devices 270 may also include interface devices for interfacing with a user of endpoint device 240, such as user 112 or 122. For example, I/O devices 270 may comprise a display, touchscreen, keyboard, mouse, trackball, touch pad, stylus, printer, or the like, configured to allow a user to interact with endpoint device 240.

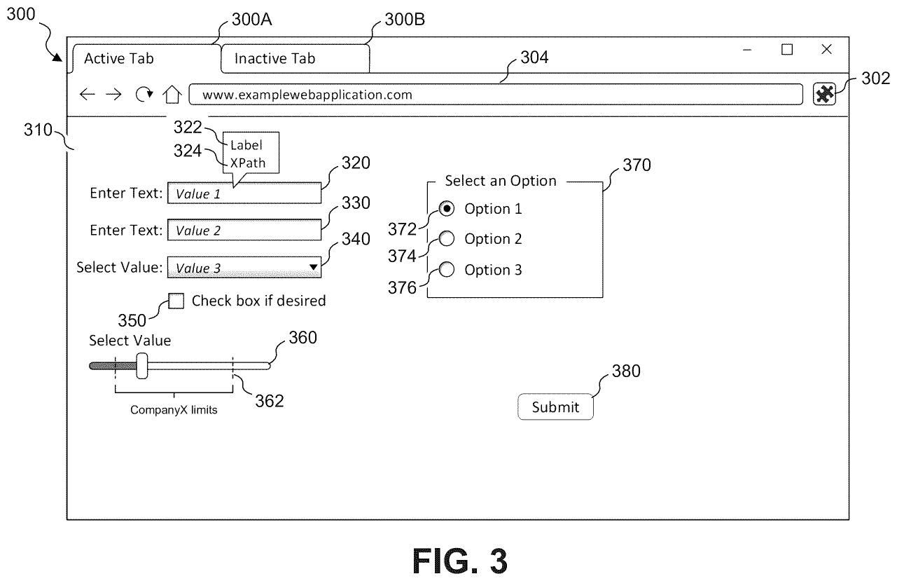

In some embodiments, the disclosed techniques may be performed through a browser application used to access various web applications. FIG. 3 illustrates an example browser application 300 through which a web application may be accessed, consistent with the disclosed embodiments. Browser application 300 may be any application configured to access webpages or other network locations through a network, such as the Internet. While a browser is used by way of example, the disclosed techniques may equally apply to other applications allowing a user to interact with a web application. In some embodiments, browser application 300 may be a web browser application, such as Google Chrome™, Mozilla Firefox™, Microsoft Edge™, Internet Explorer™, Safari™, or similar applications. Browser application 300 may execute on user endpoint device 110 and may be used by user 112 to navigate to various webpages or network locations. In some embodiments, browser application 300 may include multiple tabs, allowing browser application 300 to have multiple webpages open at the same time. For example, this may include an active tab 300A, and an inactive tab 300B, that may not be displayed.

Consistent with the present disclosure, various actions described herein may be performed by a component of browser application 300, such as browser component 302. As used herein, a browser component may refer to any form of instructions or code executed in conjunction with a browser application. In some embodiments, browser component 302 may be a native component of browser application 300. For example, browser application 300 may be a proprietary or dedicated browser application including code for executing the various techniques described herein. Alternatively or additionally, browser component 302 may be implemented as a browser extension, such as a Chrome™ extension. As used herein, a browser extension refers to a relatively small software module or component configured to supplement a browser application.

Browser component 302 may detect interface elements within a web application and enforce one or more rules associated with the elements. FIG. 3 illustrates an example web application 310 that may be accessed using browser application 300. For example, web application 310 may be associated with an address 304 accessed using browser application 300. As shown, web application 310 may include one or more interface elements, which may allow an interaction with user 112. As used herein interface elements may refer to any form of visual elements included in a web application that allow a user to interact with the web application. For example, this may include checkboxes, icons, radio buttons, progress bars, search boxes, menus, tooltips, breadcrumb navigation elements, tabs, or various other forms of display or interactive elements.

Various example interface elements are shown in FIG. 3. For example, web application 310 may include a text field, such as text field 320 or 330, which may allow a user to enter alphanumeric characters into web application 310. As another example, web application 310 may include a menu 340, which may provide a list of options that are selectable by user 112. In some embodiments, web application 310 may include various selectable options. For example, web application 310 may include a checkbox 350, which may allow a user to make a binary selection for a particular option. Similarly, web application 310 may include a set of radio options 370. Radio options 370 may allow user 112 to select from a list of mutually exclusive options 372, 374, and 376, as shown. As another example, web application 310 may include a slider bar 360, which may allow user 112 to select a value from within a predetermined range of values. Web application 310 may further include one or more buttons, which may trigger a particular command. In this example, button 380 may allow user 112 to submit the various input information selected through web application 310. While various interface elements are shown by way of example in FIG. 3, it is to be understood that the techniques described herein are not limited to any particular form of interface element.

Browser component 302 may be configured to analyze the various interface elements in web application 310 and determine whether the interface elements are associated with rules defined within system 100. For example, user 112 may authenticate themselves to begin a web session, which may include asserting one or more credentials. Once authenticated, user 112 may navigate to web application 310. Browser component 302 may find and map all interface elements on web application 310. In some embodiments, the interface elements may be associated with an identifier, which may be used to identify the interface element.

The identifier may include any form of information that may be used to distinguish other interface elements in web application 310. In some embodiments, an interface element may be associated with a label, such as a name of the interface element. For example, text field 320 may be associated with a label 322. Label 322 may be any string of text assigned to text field 320. For example, text field 320 may include a label “Textbox1” or a similar name assigned during creation of web application 310. Alternatively or additionally, various other information may be used, including a location of the interface element. For example, text field 320 may include a position 324, which may specify the position of text field 320 within web application 310. In some embodiments, position 324 may be an XPath value specifying the location of a node in an XML document. Various other position information may be used, such as x and y coordinate data, or the like.

Generally, label 322 may represent a more stable form of identifier for text field 320, as the name of the field is less likely to change. However, in some instances, the label may not necessarily be unique. For example, text fields 320 and 330 may both be associated with a label of “textbox” and thus label 322 may not uniquely identify text field 320. Accordingly, position 324 may represent a more unique identifier. In some embodiments, an identifier used for a particular interface element may be dynamic or may be based on a combination of multiple factors. For example, an identifier for text field 320 may be based on a determination of whether any other interface elements share the same label. If not, label 322 may be used. Otherwise, an alternate identifier, such as position 324, may be used. In some embodiments, an identifier may be generated for a particular interface element based on one or more properties of the interface elements. As one example, if text fields 320 and 330 share a common label of “Textbox,” system 100 may append a value to label 322 to create a unique identifier for text field 320. For example, system 100 (e.g., browser component 302) may assign integers to each interface element having duplicate label names. As one example, the integers may be assigned based on positions closest to the top left corner of web application 310. Accordingly, text field 320 may be assigned an identifier of “Textbox1” and text field 330 may be assigned an identifier of “Textbox2.” Accordingly, despite having identical labels, text fields 320 and 330 may be associated with unique identifiers. Various other methods for assigning identifiers may be used, consistent with the disclosed embodiments.

Browser component 302 may also identify rules associated with the detected interface elements. For example, the browser component 302 may ascertain an identifier for an interface element, as described above, which may be used to look up rules. In some embodiments, various rules may be stored at server 130, for example in database 132. Database 132 may include any form of data structure, such as a table, a record, a stack, a tree, or any other format for storing a collection of data values and one or more relationships among the data values. As one example, database 132 may include a reference table correlating identifiers of interface elements with one or more rules associated with the element. In some embodiments, one or more rules may be stored locally on user endpoint device 110. For example, browser component 302 may access rules in database 132 and may at least temporarily store one or more rules on user endpoint device 110.

As used herein, a rule may refer to a limitation or a requirement on how a user (e.g., user 112) may interact with a user interface. When an interface element is associated with a rule, browser component 302 may monitor activity of user 112 in association with the rule. If the rule is triggered, the browser component 302 may perform one or more control actions. In some embodiments, the control action may be a default control action, applicable to all rule violations (or rule violations of a certain type). Alternatively or additionally, a rule may define a particular control action to be performed. Accordingly, database 132 may further store actions to be taken when one or more rules are violated.

Various forms of control actions may be defined and implemented based on the rules. In some embodiments, an interaction with an interface element may include entering a value by a user and the rule may be selected based on the value that is entered. For example, the rule may define an accepted range of values to be entered into text field 320. As an illustrative example, web application 310 may be a form used by financial application that is authorized to enter a particular dollar amount to send to an entity. In some embodiments, the entity may be external (e.g., a subcontractor or vender). Alternatively or additionally, the entity may be internal (e.g., specifying an amount of employee bonus, meal value reimbursement, etc.). Text field 320 may be a field allowing a dollar amount for a financial transfer to be entered. A rule may be defined to enforce the specific amount field to be a maximum amount (e.g., $5,000) thus preventing more than the allotted amount from being transferred by the user.

As another example, a list of restricted values may be defined, and the rule may be triggered if the user enters a value determined to be restricted. For example, web application 310 may be a social media platform page and a company may use web application 310 to allow users to access and post to a corporate social media account. The public nature of these posts may present a significant reputational risk to the company if confidential or otherwise harmful information is posted. Accordingly, a rule may define a list of words or values that, if entered into text field 320, trigger a control action. Accordingly, the rule may prevent mistakes from being made, which may damage the company reputation. As another example, a rule may define a specified range of acceptable values for slider 360.

In some embodiments, any of the various rules described herein may be represented visually within web application 310. In this particular example, a guide element 362 may be overlaid on slider 360, which may indicate a range of values acceptable to an organization associated with system 100. As another example, a note may be displayed near text field 320 indicating a maximum value that may be entered. Accordingly, browser component 302 may be configured to superimpose text and other visual elements on web application 310. In some embodiments, these visual guide elements may be displayed at all times. Alternatively or additionally, the guide elements may be displayed based on a certain condition. For example, browser component 302 may display guide element 362 for certain users, based on the number of times a user has visited a web application (e.g., the first time, the first five times), based on an elapsed time since a user has visited the web application (e.g., if more than 3 months), in response to a rule violation, or any other triggers, which may be customizable for a particular rule.

In some embodiments, the control action may include modifying a value to an acceptable value. For example, if a user enters a value in text field 320 that exceeds an acceptable limit, a rule may be defined to alter the value so that it is within the acceptable limit. As another example, the control may include deleting or replacing one or more values that are found on a restricted list of values with designated replacement values. For example, this may include replacing the word “master bedroom,” entered on a real estate website, with “primary bedroom,” or other forms of replacements.

According to some embodiments, the control action may restrict interactions with one or more interface elements. For example, a control action may be defined to prevent selection of radio option 376. In some embodiments, the restriction of one element may be conditional on an interaction with another element. For example, if the user has entered a value that violates a rule in text field 320, the rule may prevent a user from selecting another interface element, such as “submit” button 380. As another example, a control action may be defined to prevent checkbox 350 from being checked if a certain value or set of values is selected from within menu 340. In some embodiments a control action may include triggering an overlay covering some or all of web application 310. For example, if user 112 attempts to navigate to a forbidden URL (or performs various other actions triggering a rule), the overlay may prevent user 112 from interacting with web application 310 further.

In some embodiments, a rule may be defined based on multiple interface elements. For example, this may include comparing values entered in two or more interface elements. In the example shown in FIG. 3, this may include comparing a value entered in text field 320 to a value entered in text field 330. If the value entered in text field 320 is higher than the value entered in text field 330, a particular control action may be performed. Similarly, rules may be defined based on various other conditions or triggers. For example, rules may be applied at certain times of day (e.g., transactions occurring after 5 pm may require manager approval), at certain times of year (e.g., blocking certain functions near the end of a fiscal year), for particular users (e.g., enforcing minimum privilege or seniority level requirements), within certain regions or locations, based on specified IP addresses (e.g., enforcing rules when working from home versus in the office), based on specified authentication statuses, based on session lengths, or the like.

Various other control actions may include causing a message to be presented to the user indicating the rule violation, causing transmission of an alert indicating the rule violation (e.g., to an administrator, etc.), triggering an additional authentication of the user, locking endpoint device 110 (e.g., if browser component 302 is a browser application), storing information identifying the user or the interaction triggering the rule, recording web session and flagging it as suspicious, or the like. In some embodiments, the control action may invoke an Application Programming Interface (“API”) for interacting with other systems, such as a REST API call. Accordingly, the control action may include marking a user as suspicious, blocking user access, updating user profiles, locking accounts, initiating specific security protocols, or a wide variety of other actions that may be performed through an API call.

In some embodiments, the control action may not be noticeable to the user but may be used for tracking and monitoring purposes. As one example, a company human resources application may have an ‘Export’ button which may export sensitive data associated with employees. Human resource users may be permitted to use this button, but the web application may not provide any forms of tracking tools to allow the company to track its use. The disclosed embodiments may be used to create a rule that causes an alert or notification to be triggered any time this button is clicked. Further, the rule may build a record of how often and in what cases this function is used. The disclosed embodiments may therefore allow improved tracking over native functions of a web application.

In some embodiments, the browser extension may allow a user, such as administrator 122, to create various rules. For example, administrator 122 may provide one or more credentials as an authentication step and may be authorized to create rules to be applied during one or more other user web sessions. Browser component 302 may provide an intuitive interface for administrator 122 to generate rules for one or more web applications. For example, after navigating to web application 310, administrator 122 may select an option to enter a “create rule” mode. In this mode, the browser extension may then map interface elements in the current page and display markers in association with the detected elements.

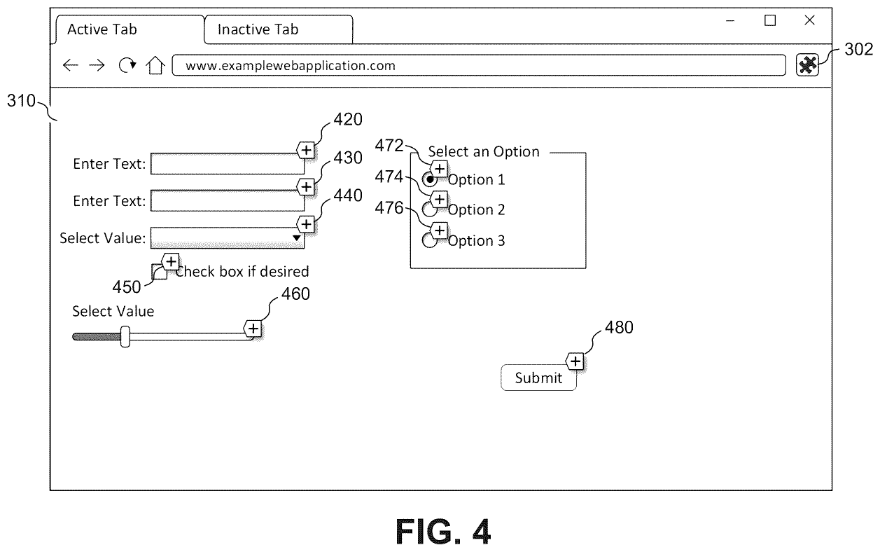

FIG. 4 illustrates an example view of web application 310 for generating rules, consistent with the disclosed embodiments. As indicated above, the view shown in FIG. 4 may represent a view shown to an administrator or other user enabled to generate rules within system 100. For example, administrator 122 may log in using browser component 302 and may select an option to generate a new rule. This may cause various markers to be overlaid on interface elements within web application 310. For example, browser component 302 may scan web application 310 and may identify any interface elements for which rules may be generated. This may be a similar scan to the one described above in which browser component 302 identifies interface elements to determine whether any stored rules apply to the identified interface elements. In this instance, however, various markers may be displayed to enable administrator 122 to create or modify rules.

Consistent with the disclosed embodiments, browser component 302 may also be configured to determine identifiers for the various interface elements as described above. Browser component 302 may be configured such that identifiers are determined consistently when creating rules and when applying and enforcing rules. Accordingly, when a rule is created, the rule may be associated with the identifier determined using browser component 302. Then, when a rule is later applied, the identifier determined by browser component 302 may be referenced when finding the previously created rule. This may allow for rules to be applied in the same manner across any web application, without relying on built-in integrations for individual webpages.

In the example shown in FIG. 4, browser component 302 may display markers 420, 430, 440, 450, 460, 472, 474, 476, and 480. Interaction with one or more of the markers may allow administrator 122 to generate a rule for the interface element associated with the marker. For example, clicking or tapping on marker 420 may enable administrator 122 to generate a rule associated with text field 320. In some embodiments, when administrator 122 selects a marker (also referred to herein as an indicator), a rule creation interface may be displayed. The rule creation interface may allow various inputs by administrator 122 to define one or more conditions associated with the interface element and one or more rules defining control actions that are performed if the conditions are met.

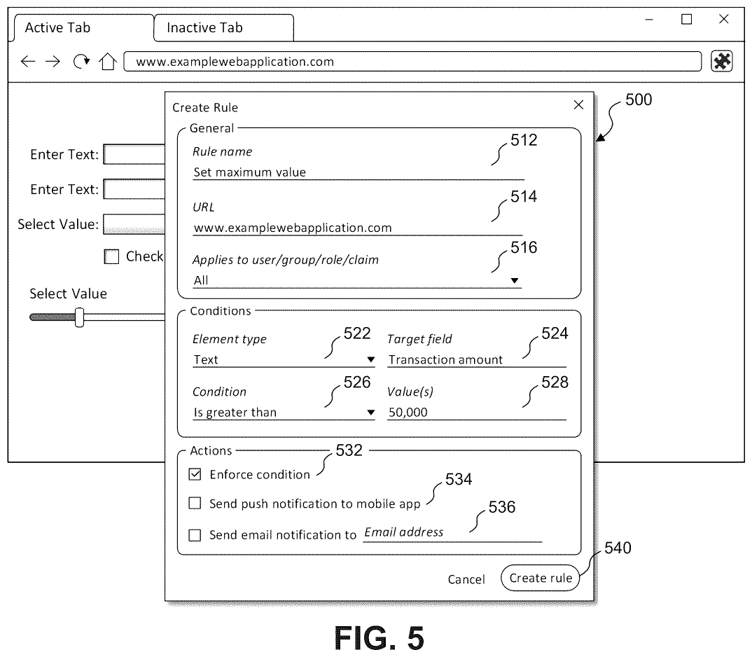

FIG. 5 illustrates an example rule creation interface 500 that may enable a user to generate one or more rules for web sessions, consistent with the disclosed embodiments. For example, rule creation interface 500 may be displayed based on an interaction with marker 420 by administrator 122. As shown in FIG. 5, rule creation interface 500 may include various input fields allowing administrator 122 to define information about a new rule. For example, rule creation interface 500 may include name field 512 for specifying a name of a rule. This name may allow administrator 122 to provide a short description of the rule. Rule creation interface 500 may further include an address field 514 specifying the URL or other address at which the rule should be applied. In some embodiments, field 514 may be filled in automatically based on the address of web application 310. Rule creation interface 500 may further include an applicability field 516 designating one or more conditions defining the applicability of the rule. For example, field 516 may be used to specify particular users or groups to which the rule is applicable. Various other example conditions are described herein.

In some embodiments, rule creation interface 500 may further allow various trigger information to be defined, which may specify when the rule is triggered. For example, rule creation interface 500 may include an element type field 522 defining the type of element the rule applies to. In this example, text field 320 may be defined as a “text” element type, as shown. Rule creation interface 500 may include a target field 524 describing the element. Condition field 526 may define a condition that, when satisfied, causes the rule to be triggered. In this example, the rule may be triggered when the value of text field 320 is greater than a value specified in a value field 528.

Rule creation interface 500 may further enable administrator 122 to specify one or more control actions that are performed when the rule is triggered. In some embodiments, a list of actions 532, 534, and 536 may be displayed, allowing administrator 122 to select which actions should apply. In this example, action 532 may enforce the condition defined in condition field 526 and value field 528 to be enforced. For example, in this case, when a user enters a transaction amount over 50,000 into text field 320 the rule would enforce a limit of 50,000. This may be accomplished by replacing the value entered in text field 320 with a value of 50,000, preventing a user from clicking button 380, or various other control actions, including those described above with respect to FIG. 3. Action 534 may cause a notification to be sent to a mobile device, such as a mobile device of administrator 122. Similarly, action 536 may cause an email to be sent to an email address, which may be specified in rule creation interface 500.

When administrator 122 has defined the rule to be created, selecting create rule button 540 may cause a rule defined by the current inputs to be stored in association with the identifier for text field 320 (or whichever interface element the rule applies to). For example, this may include storing the rule in database 132, as described above. In some embodiments, database 132 may further include the address applicable to the rule, which may be referenced when determining whether various rules are triggered by a user.

The rule creation interface shown in FIG. 5 is provided by way of example. One skilled in the art would recognize various other inputs that may be used to define any of the various rules described herein. In some embodiments, rule creation interface 500 may vary depending on the type of interface element. For example, rule creation interface 500 may provide different options and fields for text field interface elements than button elements. Further, while rule creation interface 500 is described above in association with generating a new rule, in some embodiments, rule creation interface 500 may be used for editing existing rules. For example, when editing an existing rule, rule creation interface 500 may be prepopulated with the current rule settings and may allow administrator 122 to modify any of the defined settings.

While FIG. 5 shows a rule creation interface 500 displayed in association with a web session, one skilled in the art would recognize that similar rule creation interfaces may be displayed in other applications. For example, in some embodiments, administrator 122 may create and/or modify rules when reviewing previous web session activity of a user. For example, server 130 may be configured to store recorded activity by a user associated with web application 310. For example, this may include recording clicking a mouse (e.g., left click, right click, or additional buttons), moving a mouse, hovering a mouse, touching a display screen, pressing a key on a keyboard, scrolling on a webpage, zooming in or out on a webpage, opening a new browser tab, closing a browser tab, switching to another browser tab, refreshing a webpage, navigating forward or back through the browser, resizing a browser window, navigating to another URL or web page, bookmarking a webpage, performing a copy or paste action, highlighting text or other elements of a webpage, or any other interactions by a user with a webpage, browser, or endpoint device. Server 130 may transmit at least a portion of this recorded web activity to endpoint device 120 such that it may be reviewed and/or audited by administrator 122. For example, endpoint device 120 may provide a user interface allowing administrator 122 to review various activities of user 112 performed via web application 310. Various techniques for securely recording, storing, and auditing recorded web sessions are described in further detail in U.S. Pat. No. 11,321,472, which is incorporated by reference herein in its entirety.

Consistent with the disclosed embodiments, rule creation interface 500 (or similar interfaces) may be displayed in association with a user interface for reviewing recorded web session activity. For example, administrator 122 may view recorded interactions with one or more of the various elements 320, 330, 340, 350, 360, 370, 372, 374, 376, and/or 380 by user 112 and may define rules associated with those elements. This may provide the additional benefit of allowing administrator 122 to understand the context of these interactions when assigning rules. For example, if an undesired event happens (e.g., a security breach, an unauthorized payment, an unauthorized transmission of data, etc.), administrator 122 may review the events leading up to this undesired event, and may assign rules to specific web application elements to prevent similar undesired events from happening in the future.

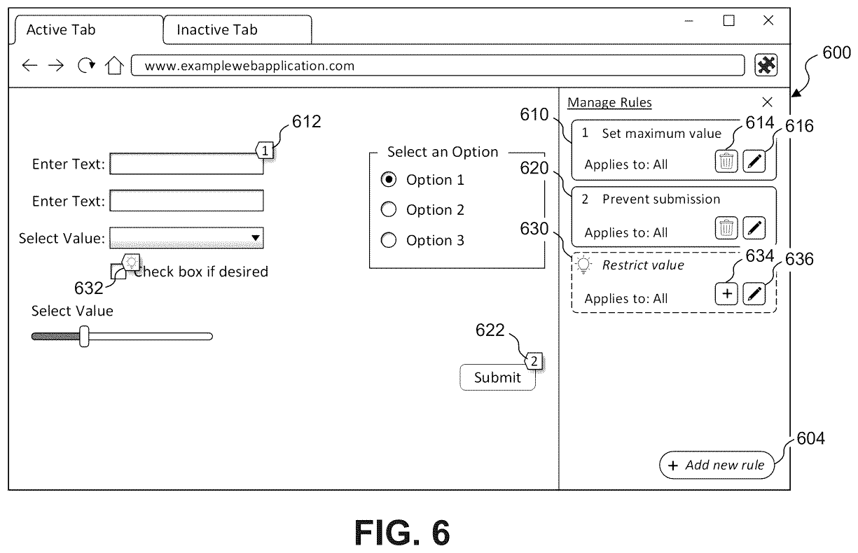

In some embodiments, system 100 may provide a rule management interface, which may enable administrator 122 to view and manage various rules within database 132. FIG. 6 illustrates an example rule management interface 600 for managing rules, consistent with the disclosed embodiments. As shown in FIG. 6, rule management interface 600 may include a list of rules associated with web application 310. In this example, web application 310 may be associated with two rules, represented by rule elements 610 and 620. In this example, rule element 610 may represent a rule associated with text field 320, and rule element 620 may represent a rule associated with button 380. Rule elements 610 and 620 may display various information associated with their respective rules. For example, rule element 610 may display a rule name (e.g., a rule name entered in rule name field 512), a rule applicability (e.g., as defined in applicability field 516), and any other information associated with a rule.

As shown in FIG. 5, the rule elements displayed in rule management interface 600 may include various interactive elements, which may allow administrator 122 to modify rules associated with web application 310. For example, rule element 610 may include a delete icon 614 and an edit icon 616. Selecting delete icon 614 may remove the rule associated with rule element 610. For example, this may include removing the rule from database 132, mark it as inactive (which may cause it not to be enforced), or the like. Selecting edit icon 616 may enable administrator 122 to edit various aspects of the associated rule. For example, this may cause rule creation interface 500 (or a similar interface) to be displayed, allowing administrator 122 to modify various aspects of the rule. In some embodiments, rule management interface 600 may include an add rule icon 604, which may allow administrator 122 to create a new rule. For example, selecting add rule icon 602 may cause indicators to be displayed (as described above with respect to FIG. 4), may cause rule creation interface 500 to be displayed, or the like.

In some embodiments, browser component 302 may display various indicators (e.g., indicators 612 and 622) showing which elements of web application 310 have associated rules defined, as shown in FIG. 5. In some embodiments, the indicators may have visual cues linking the indicators to the rule elements displayed in rule management interface 600. For example, indicator 612 and rule element 610 may each have a “1” indicating that indicator 612 corresponds to the same rule as rule element 610, as shown. Various other visual cues may be used, such as matching colors, matching icons, or the like.

The rule management interface shown in FIG. 6 is provided by way of example. One skilled in the art would recognize various other configurations may be used to allow an administrator to manage rules within system 100. For example, while rule management interface 600 is generally described as displaying rules associated with a particular web application, rule management interface 600 may enable an administrator to view rules associated with many web applications simultaneously. For example, rule management interface 600 may include all rules associated with the organization that administrator 122 belongs to. Rule management interface 600 may allow administrator 122 to filter the rules in various ways, such as by type, by creation date, by creation entity, by applicability, by control action, or the like.

As described above, rules created within system 100 may be stored in database 132. In some embodiments, system 100 may leverage these rules for generating recommendations for new rules to be added by an administrator. For example, this may include analyzing all of the rules for an organization and identifying interface elements that may be good candidates for rules with settings similar to those already stored in database 132. For example, if the organization consistently generates a rule restricting actions for checkboxes having certain properties, system 100 may identify other checkboxes having those properties and suggest a rule be added. According to some embodiments, a suggestion may be generated based on rules associated with multiple organizations. For example, database 132 may store rules associated with a first organization and a second organization. Using the techniques described herein, system 100 may suggest a rule for the second organization based on similar rules created by the first organization. In this scenario, an administrator of the second organization may not have access to the rules of the first organization, but may receive recommendations that may also be useful for the second organization.

This feature may be implemented in various ways. FIG. 6 includes an example of how such rule recommendations may be implemented. For example, rule management interface 600 may include a suggested rule element 630, which may show a rule that is not yet active or stored in database 132, but may have various settings defined based on existing or previous rules. As with rule elements 610 and 620, suggested rule element 630 may have an associated indicator 632 highlighting the interface element the rule would be applicable to. In some embodiments, suggested rule element 630 may include an add icon 634 allowing administrator 122 to accept the proposed rule. Alternatively or additionally, suggested rule element 630 may include an edit icon 636, allowing administrator 122 to view and edit the details for the proposed rule before accepting and creating the rule.

A rule suggestion may be generated in various ways. In some embodiments, the suggested rule may be based on one or more existing rules, as described above. In some embodiments, the suggested rule may be generated based on an attribute of the interface element the suggested rule is based on. The attribute may include a type of interface element, text associated with the interface element, an appearance of the interface element, a position within the web application of the interface element, a frequency of use of the interface element, or any other potential attributes or various combinations thereof. System 100 (e.g., server 130) may compare attributes of interface elements on a web application with attributes of interface elements associated with rules stored in database 132. Accordingly, rule suggestions may be generated based on rules associated with interface elements having similar attributes.

In some embodiments, a machine learning model may be implemented for generating one or more rule suggestions. For example, a training data set of rules may be input into a machine learning algorithm. The training data set may include various web applications and interface elements, along with rules associated with those elements. Accordingly, the training data set may represent a labeled set of web applications. As a result of the training process, a model may be generated to analyze an input web application and suggest one or more rules. In some embodiments, the trained model may be an artificial neural network configured to generate the suggested rules. Various other machine learning algorithms may be used, including a logistic regression, a linear regression, a regression, a random forest, a K-Nearest Neighbor (KNN) model, a K-Means model, a decision tree, a cox proportional hazards regression model, a Naïve Bayes model, a Support Vector Machines (SVM) model, a gradient boosting algorithm, a deep learning model, or any other form of machine learning model or algorithm.

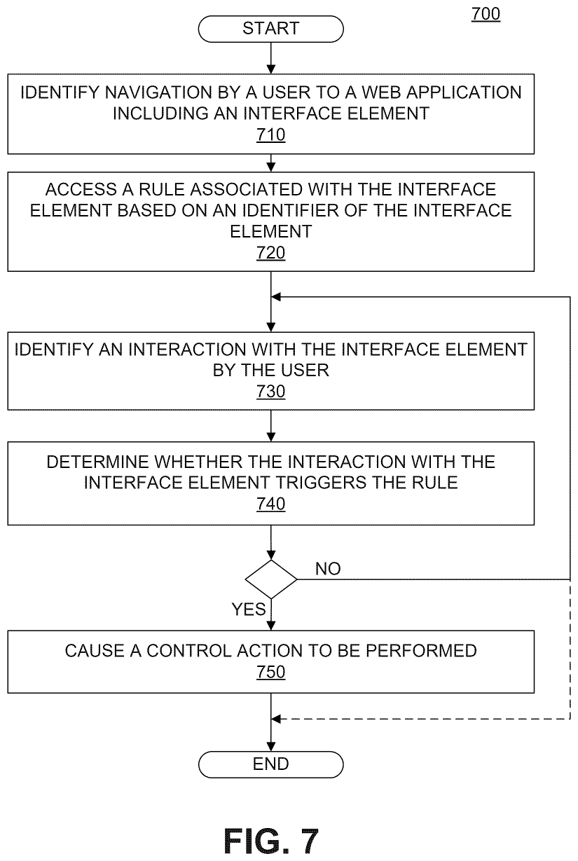

FIG. 7 is a flowchart showing an example process 700 for controlling web sessions, consistent with the disclosed embodiments. Process 700 may be performed by at least one processor of a computing device, such as processor 210, as described above. Alternatively or additionally, some or all of process 700 may be performed by at least one processor of a server, such as processor 230. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform some or all of process 700. Further, process 700 is not necessarily limited to the steps shown in FIG. 7, and any steps or processes of the various embodiments described throughout the present disclosure may also be included in process 700, including those described above with respect to, for example, FIGS. 3, 4, 5, and 6.

In step 710, process 700 may include identifying navigation by a user to a web application, the web application including at least one interface element. For example, this may include identifying navigation by user 112 to web application 310. As described above, the navigation by the user to the web application may be identified by a browser component executing on an endpoint device. In some embodiments, the browser component may be implemented as a browser extension, such as an extension to browser application 300. Alternatively or additionally, the browser component may be a native component of browser application 300.

In step 720, process 700 may include accessing at least one rule associated with the at least one interface element. For example, this may include accessing at least one rule associated with one or more of the various elements 320, 330, 340, 350, 360, 370, 372, 374, 376, and/or 380, as shown in FIG. 3. As described above, the at least one rule may be accessed based on an identifier of the at least one interface element. In some embodiments, the identifier may be a name of the at least one interface element. For example, the identifier may include label 322. Alternatively or additionally, the identifier may be a position of the at least one interface element. For example, the identifier may include position 324. In some embodiments, the name and position may be used to form the identifier, as described above.

In step 730, process 700 may include identifying an interaction with the at least one interface element by the user. For example, this may include determining that the user has clicked on the at least one interface element, tapped the at least one interface element, entered a value using the at least one interface element, selected the at least one interface element, or the like.

In step 740, process 700 may include determining whether the interaction with the at least one interface element triggers the at least one rule. For example, as described above, the at least one rule may be associated with various trigger information specifying when the rule is triggered. A wide variety of triggers may be defined, which may depend on the type of interface element the at least one rule is associated with. For example, the interaction with the at least one interface element may include a value being input by the user, as described above. Accordingly, determining whether the interaction with the at least one interface element triggers the at least one rule may include determining whether the value triggers the at least one rule. In some embodiments, the user may input the value by selecting from a closed list of available values. For example, the user may input the value using menu 340 or radio options 370. Alternatively or additionally, the user may enter the value as an alphanumerical text in a field, such as text field 320 or 330. Determining whether the value triggers the at least one rule may include determining whether the value is within an accepted range of values. Alternatively or additionally, determining whether the value triggers the at least one rule may include determining whether the value includes at least one restricted value. For example, this may include comparing the value to one or more predefined restricted values to determine if the value violates the at least one rule.

In some embodiments, rules may be defined such that they are violated based on interactions with multiple elements. Accordingly, the at least one interface element may include a first interface element and a second interface element and the interaction with the at least one interface element may include an interaction with the first interface element and an interaction with the second interface element by the user. The determination whether the interaction with the at least one interface element triggers the at least one rule may be based on the interaction with the first interface element and the interaction with the second interface element. For example, this may include taking a sum of values entered in multiple fields (or various other mathematical operators), comparing values entered in multiple fields with each other, conditional rules based on multiple elements (e.g., if checkbox 350 is checked, a first restriction applies to menu 340, whereas if checkbox 350 is not checked, a second restriction applies to menu 340), determining if multiple elements are selected, or the like.

In step 750, process 700 may include causing a control action to be performed based on a determination that the interaction with the at least one interface element triggers the at least one rule. As with the types of rules, a wide variety of control actions may be defined. For example, as described above, the interaction with the at least one interface element may include a value being input by the user. The control action may include changing the value to a modified value. For example, the modified value may be a value that does not trigger the at least one rule. As another example, the control action may include restricting an interaction with at least one additional interface element of the web application by the user. For example, if the user enters a restricted value in text field 320, the control action may include preventing the user from clicking button 380.

In some embodiments, the control action may include causing a message to be presented to the user. For example, the message may indicate the interaction with the at least one interface element triggers the at least one rule. In some embodiments, causing the message to be presented may include causing the message to be overlaid on the web application. In some embodiments, the message may include context information indicating how the rule was violated or guiding the user to correct the violation. For example, this may include displaying guide element 362. As another example, the control action may include causing transmission of an alert indicating the at least one rule has been triggered. For example, this may include transmitting an alert to a device associated with administrator 122. According to some embodiments, the control action may include storing information identifying at least one of the user or the interaction with the at least one interface element. As another example, the control action may include locking the endpoint device.

In some embodiments, process 700 may further include validating an identity of the user. For example, this may include validating a secret associated with the user (e.g., an SSO token, a password, a username, a hash, etc.) or various other forms of authentication. In some embodiments, the at least one rule may be specific to a user or group of users. For example, determining whether the interaction with the at least one interface element triggers the at least one rule may be based on the identity of the user. The control action may include triggering an additional authentication of the identity of the user. For example, this may include rotating a credential of the user, requiring an additional authentication factor (e.g., in a multi-factor authentication scheme), or the like.

As described above, the disclosed embodiments may allow a user, such as administrator 122 to create various rules. Accordingly, process 700 may further include creating the at least one rule based on an input by at least one additional user. For example, the input by the at least one additional user may include information defining a condition associated with the at least one interface element, as described above. The determination of whether the interaction with the at least one interface element triggers the at least one rule may be based on a comparison of the interaction with the at least one interface element with the condition. In some embodiments, the input by the at least one additional user may include information defining the control action.

In some embodiments, the input from at least one additional user may be received in association with the at least one element when the at least one additional user navigates to the web application. For example, administrator 122 may navigate to the web application and a browser component running on endpoint device 120 may allow administrator 122 to create one or more rules, as described above. In some embodiments, process 700 may include detecting the at least one interface element and causing an indicator to be displayed in association with the at least one interface element. For example, this may include displaying markers 420, 430, 440, 450, 460, 472, 474, 476, and 480. The input by the at least one additional user may thus be received through an interaction with the indicator, as described above. Consistent with the disclosed embodiments, information defining a condition associated with the at least one interface element may be received through the rule creation interface and an appearance of the rule creation interface may be determined based on a type of the at least one interface element.

In some embodiments, creating the at least one rule may further include causing a rule creation interface to be displayed in association with the at least one interface element. For example, this may include causing rule creation interface 500 to be displayed. Accordingly, the input by the at least one additional user may be received through the rule creation interface. In some embodiments, the rule creation interface may be overlaid on the web application, for example, as shown in FIG. 5. In some embodiments, an appearance of the rule creation interface may be determined based on a type of the at least one interface element. For example, the rule creation interface may appear different for a text box than it does for a slider bar. Similarly, system 100 may further allow a user (e.g., administrator 122) to update or modify one or more rules. Accordingly, process 700 may further include modifying the at least one rule based on an additional input by the at least one additional user.

As described above, process 700 may allow creation of one or more rules in other contexts as well. For example, system 100 may be configured to record web session activity associated with a user and allow the recorded web session activity to be audited, for example by administrator 122. Accordingly, in creating the at least one rule based on an input by at least one additional user, the input may be received in association with recorded browser session data.

In some embodiments, process 700 may further include operations for generating suggestions for one or more rules, as described above. For example, process 700 may include accessing a plurality of stored rules. Each of the plurality of stored rules may be associated with a corresponding interface element. Process 700 may include generating a suggestion to the at least one additional user to create the at least one rule based on the plurality of stored rules. For example, generating the suggestion may include identifying the at least one rule based on a comparison of at least one attribute of the at least one interface element with attributes of interface elements associated with the plurality of stored rules. In some embodiments, the suggestion may be generated based on application of a trained machine learning model, as described above. The input by the at least one additional user may be received based on the suggestion (e.g., through accepting the suggestion, modifying the suggestion, etc.).

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A non-transitory computer readable medium including instructions that, when executed by at least one processor, cause the at least one processor to perform operations for controlling web sessions, the operations comprising:
identifying, by a browser component executing on an endpoint device, navigation by a user to a web application, the web application including at least one interface element;
creating at least one rule based on an input from at least one additional user, wherein the input from at least one additional user is received in association with the at least one element when the at least one additional user navigates to the web application;
accessing, based on an identifier of the at least one interface element, the at least one rule associated with the at least one interface element;
identifying an interaction with the at least one interface element by the user;
determining whether the interaction with the at least one interface element triggers the at least one rule; and
based on a determination that the interaction with the at least one interface element triggers the at least one rule, causing a control action to be performed.

2-16. (canceled).

17. A computer-implemented method for controlling web sessions, the method comprising:
identifying, by a browser component executing on an endpoint device, navigation by a user to a web application, the web application including at least one interface element;
creating at least one rule based on an input from at least one additional user, wherein the input from at least one additional user is received in association with the at least one element when the at least one additional user navigates to the web application;
accessing, based on an identifier of the at least one interface element, the at least one rule associated with the at least one interface element determining the at least one rule is associated with the at least one interface element;
identifying an interaction with the at least one interface element by the user;
determining whether the interaction with the at least one interface element triggers the at least one rule; and
based on a determination that the interaction with the at least one interface element triggers the at least one rule, causing a control action to be performed.

18. (canceled)

19. The computer-implemented method of claim 17, wherein the method further includes:
detecting the at least one interface element; and
causing an indicator to be displayed in association with the at least one interface element, wherein the input from the at least one additional user is received through an interaction with the indicator.

20. The computer-implemented method of claim 17, wherein creating the at least one rule further includes causing a rule creation interface to be displayed in association with the at least one interface element, and wherein the input from the at least one additional user is received through the rule creation interface.

21. The computer-implemented method of claim 20, wherein the rule creation interface is overlaid on the web application.

22. The computer-implemented method of claim 20, wherein the input from the at least one additional user is received in association with recorded browser session data.

23. The computer-implemented method of claim 17, wherein the at least one rule is created based on an input from at least one additional user, and wherein the method further includes:
accessing a plurality of stored rules, each of the plurality of stored rules being associated with a corresponding interface element; and
generating a suggestion to the at least one additional user to create the at least one rule based on the plurality of stored rules.

24. The computer-implemented method of claim 23, wherein generating the suggestion includes identifying the at least one rule based on a comparison of at least one attribute of the at least one interface element with attributes of interface elements associated with the plurality of stored rules.

25. The computer-implemented method of claim 17, wherein the method further includes creating the at least one rule based on an input from at least one additional user, and wherein the input from the at least one additional user includes information defining a condition associated with the at least one interface element, wherein the determination of whether the interaction with the at least one interface element triggers the at least one rule is based on a comparison of the interaction with the at least one interface element with the condition.

26. The computer-implemented method of claim 25, wherein the information defining a condition associated with the at least one interface element is received through a rule creation interface and wherein an appearance of the rule creation interface is determined based on a type of the at least one interface element.

27. The non-transitory computer readable medium of claim 1, wherein the operations further include:
detecting the at least one interface element; and
causing an indicator to be displayed in association with the at least one interface element, wherein the input from the at least one additional user is received through an interaction with the indicator.

28. The non-transitory computer readable medium of claim 1, wherein creating the at least one rule further includes causing a rule creation interface to be displayed in association with the at least one interface element, and wherein the input from the at least one additional user is received through the rule creation interface.

29. The non-transitory computer readable medium of claim 28, wherein the rule creation interface is overlaid on the web application.

30. The non-transitory computer readable medium of claim 28, wherein the input from the at least one additional user is received in association with recorded browser session data.

31. The non-transitory computer readable medium of claim 1, wherein the at least one rule is created based on an input from at least one additional user, and wherein the operations further include:
accessing a plurality of stored rules, each of the plurality of stored rules being associated with a corresponding interface element; and
generating a suggestion to the at least one additional user to create the at least one rule based on the plurality of stored rules.

32. The non-transitory computer readable medium of claim 31, wherein generating the suggestion includes identifying the at least one rule based on a comparison of at least one attribute of the at least one interface element with attributes of interface elements associated with the plurality of stored rules.

33. The non-transitory computer readable medium of claim 1, wherein the operations further include creating the at least one rule based on an input from at least one additional user, and wherein the input from the at least one additional user includes information defining a condition associated with the at least one interface element, wherein the determination of whether the interaction with the at least one interface element triggers the at least one rule is based on a comparison of the interaction with the at least one interface element with the condition.

34. The non-transitory computer readable medium of claim 33, wherein the information defining a condition associated with the at least one interface element is received through a rule creation interface and wherein an appearance of the rule creation interface is determined based on a type of the at least one interface element.
